(19) United States
(12) Patent Application Publication
(10) Pub. No.: US 2021/0341223 A1
(43) Pub. Date: Nov. 4, 2021

(54) COMPUTERIZED MONITORING SYSTEM FOR A TURBO-EXPANDER BRAKE COMPRESSOR

(71) Applicant: Saudi Arabian Oil Company, Dhahran (SA)

(72) Inventors: Vadim Goryachikh, Al`Udhailiyyah (SA); Abdulrahman Takrouni, Al`Udhailiyyah (SA); Fahad Alghamdi, Al`Udhailiyyah (SA)

(21) Appl. No.: 16/862,193

(22) Filed: Apr. 29, 2020

(51) Int. Cl. F25J 1/02; G05B 19/042; F25J 1/00; G06T 11/00

(52) U.S. Cl. CPC F25J 1/0281; G05B 19/0428; F25J 1/0022; G06T 2200/24; G05B 2219/23258; G05B 2219/25232; F25J 2230/22; G06T 11/00

(57) ABSTRACT

In an example implementation, a distributed control system (DCS) receives sensor data from one or more sensors regarding an operation of a turbo-expander brake compressor, determines one or more performance characteristics regarding the operation of the turbo-expander brake compressor the based on the sensor data, and causes at least some of the one or more performance characteristics to be presented to a user using a graphical dashboard interface during the operation of the turbo-expander brake compressor. Further, the DCS determines, based on the one more performance characteristics, that the operation of the turbo-expander brake compressor satisfies one or more notification criteria. In response, the distributed control system causes a notification to be presented to the user using the graphical dashboard interface.

### TECHNICAL FIELD

The disclosure relates to computerized monitoring systems for turbo-expander brake compressors.

### BACKGROUND

A turbo-expander brake compressor is a system that generates power based on the expansion of high-pressure gas (for example, using a turbo-expander) and uses generated power to re-compress low-pressure gas (for example, using a brake compressor). In some implementations, a turbo-expander brake compressor can be used as a part of a process for extracting hydrocarbon liquids from natural gas.

### SUMMARY

Systems and techniques for monitoring the operation of turbo-expander brake compressor are described in this disclosure. In an example implementation, a distributed control system can determine the operating point of the turbo-expander brake compressor with respect to a performance curve and identify various safety limits for the turbo-expander brake compressor (for example, surge limits and stonewall limits). Further, the distributed control system can present this information to a user in the form of a graphical dashboard in real-time, such that the user can maintain the turbo-expander brake compressor within a safety envelope. Further, the distributed control system can generate notifications or alarms if the turbo-expander brake compressor approaches or exceeds the safety limits and provide guidance to the user to return the turbo-expander brake compressor back to the safety envelope. Further, the distributed control system can monitor other properties of the turbo-expander brake compressor, such as the input and output of the turbo-expander brake compressor. Further, the distributed control system can calculate performance characteristics such as polytrophic head, the polytrophic efficiency of the turbo-expander brake compressor, and the absorbed power of turbo-expander brake compressor.

The implementations described in this disclosure can provide various technical benefits. As an example, a distributed control system can provide information regarding the operation of a turbo-expander brake compressor to a user in real-time or substantially real-time, such that the user can safely operate the turbo-expander brake compressor. This enables the user to reduce the risk of damaging the turbo-expander brake compressor, damaging other equipment or machinery, or injuring others during operation. Thus, the turbo-expander brake compressor can be operated more reliably and safely.

In an aspect, a method includes receiving, by a distributed control system, sensor data from one or more sensors regarding an operation of a turbo-expander brake compressor; determining, by the distributed control system based on the sensor data, one or more performance characteristics regarding the operation of the turbo-expander brake compressor; causing, by the distributed control system during the operation of the turbo-expander brake compressor, at least some of the one or more performance characteristics to be presented to a user using a graphical dashboard interface; determining, by the distributed control system based on the one more performance characteristics, that the operation of the turbo-expander brake compressor satisfies one or more notification criteria; and responsive to determining that the operation of the turbo-expander brake compressor satisfies the one or more notification criteria, causing, by the distributed control system, a notification to be presented to the user using the graphical dashboard interface.

Implementations of this aspect can include one or more of the following features.

In some implementations, sensor data can be received continuously during the operation of the turbo-expander brake compressor.

In some implementations, the one or more performance characteristics can be determined continuously during the operation of the turbo-expander brake compressor.

In some implementations, the distributed control system can cause the at least some of the one or more performance characteristics to be presented to the user continuously during the operation of the turbo-expander brake compressor.

In some implementations, the sensor data can include at least one of: an indication of a composition of input gas directed into the turbo-expander brake compressor during the operation of the turbo-expander brake compressor, an indication of a pressure of the input gas, an indication of a temperature of the input gas, or an indication of a flow rate of the input gas.

In some implementations, the sensor data can include an indication of a rotational speed of a component of the turbo-expander brake compressor during the operation of the turbo-expander brake compressor.

In some implementations, the sensor data can include at least one of: an indication of a pressure of output gas discharged from the turbo-expander brake compressor during the operation of the turbo-expander brake compressor, or an indication of a temperature of the output gas.

In some implementations, the one or more performance characteristics can include a surge limit of the turbo-expander brake compressor, and a deviation of the turbo-expander brake compressor from the surge limit during the operation of the turbo-expander brake compressor.

In some implementations, the one or more performance characteristics can include a stonewall limit of the turbo-expander brake compressor, and a deviation of the turbo-expander brake compressor from the stonewall limit during the operation of the turbo-expander brake compressor.

In some implementations, the one or more performance characteristics can include a polytrophic efficiency of the turbo-expander brake compressor during the operation of the turbo-expander brake compressor.

In some implementations, the one or more performance characteristics can include an absorbed power of the turbo-expander brake compressor during the operation of the turbo-expander brake compressor.

In some implementations, the one or more performance characteristics can include an operating point of the turbo-expander brake compressor relative to a performance curve of the turbo-expander brake compressor.

In some implementations, the graphical dashboard interface can include a graphical representation of the operating point overlaid on a graphical representation of the performance curve.

In some implementations, determining that the operation of the turbo-expander brake compressor satisfies the one or more notification criteria can include determining that the operation of the turbo-expander brake has exceeded a safety limit associated with the turbo-expander brake compressor.

In some implementations, the notification can include an indication that the operation of the turbo-expander brake has exceeded the safety limit.

In some implementations, determining that the operation of the turbo-expander brake compressor satisfies the one or more notification criteria can include determining that the operation of the turbo-expander brake is approaching a safety limit associated with the turbo-expander brake compressor.

In some implementations, the notification can include an indication that the operation of the turbo-expander brake is approaching the safety limit.

In some implementations, the method can further include determining, by the distributed control system based on the one more performance characteristics, an estimated future deterioration of the turbo-expander brake compressor, and causing, by the distributed control system, an indication of the estimated future deterioration to be presented to the user using the graphical dashboard interface.

In another aspect, a system includes one or more processors, and one or more non-transitory computer-readable media including one or more sequences of instructions which, when executed by the one or more processors, causes the one or more processors to perform various operations. The operations include receiving sensor data from one or more sensors regarding an operation of a turbo-expander brake compressor; determining, based on the sensor data, one or more performance characteristics regarding the operation of the turbo-expander brake compressor; causing, during the operation of the turbo-expander brake compressor, at least some of the one or more performance characteristics to be presented to a user using a graphical dashboard interface; determining, based on the one more performance characteristics, that the operation of the turbo-expander brake compressor satisfies one or more notification criteria; and responsive to determining that the operation of the turbo-expander brake compressor satisfies the one or more notification criteria, causing a notification to be presented to the user using the graphical dashboard interface.

In another aspect, one or more non-transitory computer-readable media includes one or more sequences of instructions which, when executed by the one or more processors, causes the one or more processors to perform various operations. The operations include receiving sensor data from one or more sensors regarding an operation of a turbo-expander brake compressor; determining, based on the sensor data, one or more performance characteristics regarding the operation of the turbo-expander brake compressor; causing, during the operation of the turbo-expander brake compressor, at least some of the one or more performance characteristics to be presented to a user using a graphical dashboard interface; determining, based on the one more performance characteristics, that the operation of the turbo-expander brake compressor satisfies one or more notification criteria; and responsive to determining that the operation of the turbo-expander brake compressor satisfies the one or more notification criteria, causing a notification to be presented to the user using the graphical dashboard interface.

Other implementations are directed to systems, devices, and devices for performing some or all of the method. Other implementations are directed to one or more non-transitory computer-readable media including one or more sequences of instructions which when executed by one or more processors causes the performance of some or all of the method.

The details of one or more embodiments are set forth in the accompanying drawings and the description. Other features and advantages will be apparent from the description and drawings, and from the claims.

### BRIEF DESCRIPTION OF DRAWINGS

FIG. 1 is a diagram of an example turbo-expander brake compressor system.

FIG. 2 is a simplified schematic diagram of an example distributed control system for monitoring the operation of a turbo-expander brake compressor.

FIG. 3 is a simplified process schematic for generating performance characteristics regarding turbo-expander brake compressor.

FIG. 4A-4C are diagrams of an example graphical dashboard for presenting information to a user during operation of a turbo-expander brake compressor.

FIG. 5 is a diagram of an example gas compressibility correlation for residue gas in an example natural gas recovery plant.

FIG. 6 is a flow chart diagram of an example process for monitoring the operation of a turbo-expander brake compressor.

FIG. 7 is a schematic diagram of an example computer system.

### DETAILED DESCRIPTION

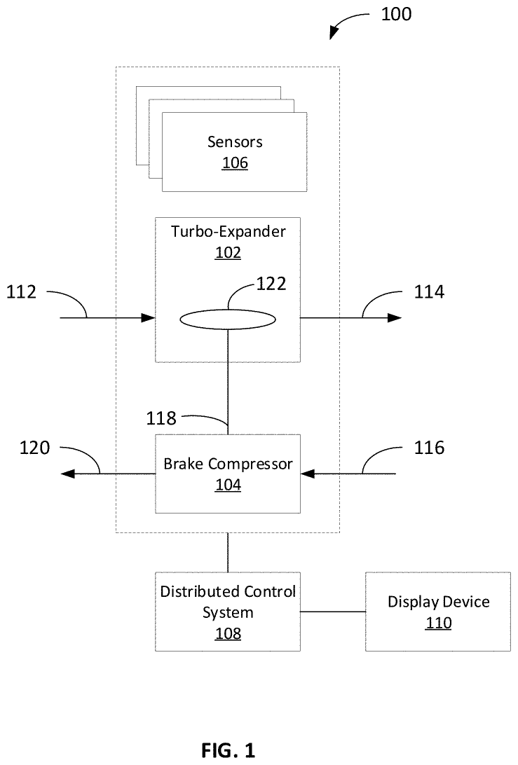

An example turbo-expander brake compressor system 100 is shown in FIG. 1. The system 100 includes a turbo-expander 102, a brake compressor 104, one or more sensors 106, a distributed control system 108, and a display device 110.

During an example operation of the system 100, the turbo-expander 102 receives gas via an inlet 112 and allows the gas to expand within an impeller wheel 122 of the turbo-expander 102. As the gas expands, power is extracted from the expanding gas using the impeller wheel 122 and is transferred by mechanical connection 118 (e.g., a coupling or shaft) 118 to the brake compressor 104. The expanded gas is then expelled from the turbo-expander 102 via an outlet 114 for further processing. Due the expansion of the gas within the turbo-expander 102, the gas that is input into the inlet 112 has a higher pressure than the gas that is expelled from the outlet 114.

After the gas has been processed, at least some of the processed gas is input into the brake compressor 104 via an inlet 116. The brake compressor 104 compresses the gas, using the power generated by the turbo-expander 102. For example, as described above, the power generated by the turbo-expander 102 can be provided to the brake compressor 104 via the mechanical connection 118 extending between them, and the provided power can be used to drive a compression rotor of the brake compressor 104 to compress the gas. The compressed gas is then expelled from the brake compressor 104 via an outlet 120. Due the compression of the gas within the brake compressor 104, the gas that is input into the inlet 116 has a lower pressure than the gas that is expelled from the outlet 120.

During operation of the system 100, the distributed control system (DCS) 108 continuously monitors the turbo-expander 102 and brake compressor 104 (for example, using the sensors 106) and provides information to a user of the system 100 (for example, using the display device 110). As an example, the DCS 108 can determine information such as the current condition of the system 100, a historical condition of the system 100, and an estimated future condition of the system 100. Further, the DCS 108 can provide at least some of the information to the user in the form of a graphical dashboard in real-time or substantially real-time, such that the user is apprised of the condition of the system 100 during operation. Further, the DCS 108 can provide notifications or alarms to the user if the system 100 exceeds or is in danger of exceeding its safety limits. Further, the DCS 108 can provide the user with guidance to return the system 100 within its safety limits or to avoid operating the system 100 beyond its safety limits preemptively (for example, by generating and presenting one or more guide messages instructing the user to check the functionality of the safety mechanisms of the turbo-expander brake compressor system, modify the operation of the turbo-expander brake compressor system, or other such messages).

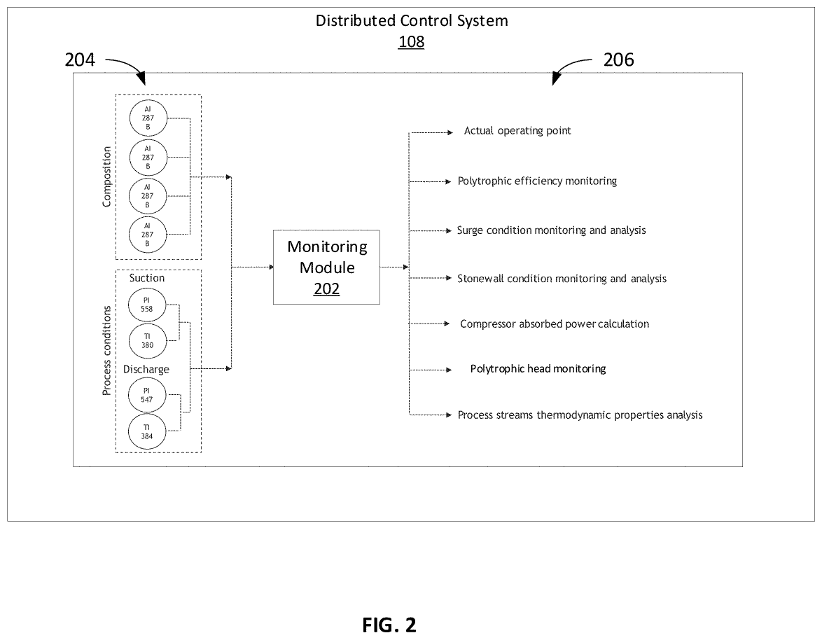

FIG. 2 is a simplified schematic diagram of an example DCS 108. As shown in FIG. 2, the DCS 108 includes a monitoring module 202 that receives input data 204 (for example, from the sensors 106) and calculates performance characteristics 206 regarding the operation of the system 100 based on the input data 204. In some implementations, the DCS 108 can calculate one or more of the performance characteristics 206 algorithmically based on the input data 204.

The monitoring module 202 can receive various types of input data 204. As an example, the DCS 108 can receive information regarding the composition of gas at one or more locations of the system 100 (for example, at the inlet 112, the outlet 114, the inlet 116, and the outlet 120). As another example, the monitoring module 202 can receive information regarding other properties of the gas at one or more locations of the system 100, such as the pressure of the gas, the temperature of the gas, and the flow rate of the gas. The input data 204 can be generated, for example, by one or more gas composition sensors, pressure sensors, temperature sensors, and flow rate sensors disposed at one or more locations of the system 100. In some implementations, at least some of the input data 204 can be received in real-time or substantially real-time.

The monitoring module 202 can calculate various types of performance characteristics 206 based on the input data 204. As an example, the monitoring module 202 can determine the current operating point of the system 100 (for example, the current condition of the system 100 with respect to one or more metrics). As another example, the monitoring module 202 can determine an actual polytrophic efficiency of the system 100 (for example, the polytrophic efficiency of gas compression by the brake compressor 104). As another example, the monitoring module 202 can determine a polytrophic head of the system 100 (for example, the amount of work required per pound of gas compressed by the brake compressor 104). As another example, the monitoring module 202 can determine the surge limit of the system 100 and monitor the system 100 with respect to that limit (for example, to determine whether the system 100 has exceed the surge limit or is danger of exceeding the surge limit). As another example, the monitoring module 202 can determine the stonewall limit of the system 100 and monitor the system 100 with respect to that limit (for example, to determine whether the system 100 has exceed the stonewall limit or is danger of exceeding the stonewall limit). As another example, the monitoring module 202 can determine the power that is absorbed by components of the system 100 (for example, by the brake compressor 104). As another example, the monitoring module 202 can determine the thermodynamic properties of the streams of gas that are input and expelled from the system 100. Example techniques for generating performing characteristics are described in further detail below.

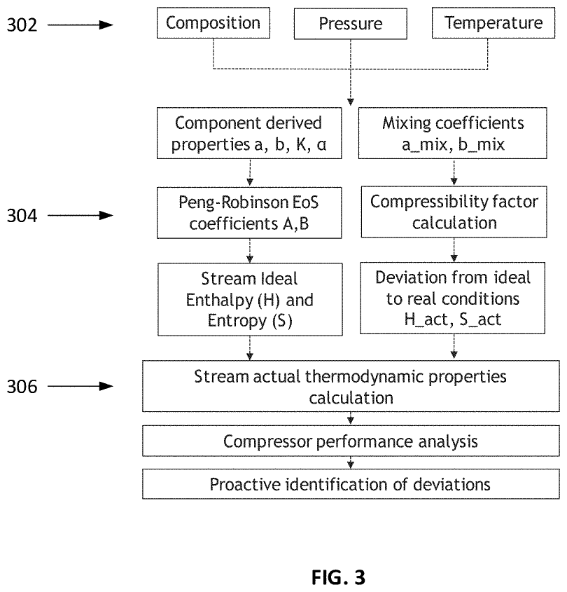

In some implementations, the monitoring module 202 can generate performance characteristics regarding the system 100 based on one or more specific thermodynamic properties of the streams of gas in the system 100. In turn, these thermodynamic properties can be used to assess the operation of the system 100. As an example, FIG. 3 shows a simplified process schematic for generating performance characteristics regarding the system 100.

As shown in FIG. 3, the monitoring module 202 receives input data 302. As an example, the monitoring module 202 can receive input data 302 regarding the gas at one or more locations of the system 100 (for example, at the inlet 112, the outlet 114, the inlet 116, and the outlet 120). The input data 302 can include, for instance, the composition of the gas, the pressure of the gas, the temperature of the gas, and the flow rate of the gas. The input data 302 can be generated, for example, by one or more gas composition sensors, pressure sensors, temperature sensors, and flow rate sensors disposed at one or more locations of the system 100.

Based on the input data 302, the monitoring module 202 determines one or more parameters 304 regarding the system 100. Each of these parameters 304 is discussed in further detail below.

Based on the parameters 304, the monitoring module 202 determines one or more thermodynamic properties 306 regarding one or more gas streams in the system 100. Example techniques for calculating one or more thermodynamic properties are discussed in further detail below.

Based on the thermodynamic properties 306, the monitoring module 202 determines analyses the performance of the system 100. Example analysis techniques are described in further detail below.

Further, the monitoring module 202 can present at least some of the generated data to the user, such that the user is apprised of the condition of the system 100 during operation. Further, the monitoring module 202 can provide notifications or alarms to the user if the system 100 exceeds or is in danger of exceeding its safety limits. Further, the DCS 108 can provide the user with guidance to return the system 100 within its safety limits or to avoid operating the system 100 beyond its safety limits preemptively.

In some implementations, at least some of the generated data can be presented to the user using a graphical dashboard continuously during the operation of the system 100 in real-time or substantially real-time (for example, using the display device 110). Further, notifications or alarms can be presented to the user via graphical alerts or other types of alerts (for example, auditory alerts using an audio speaker).

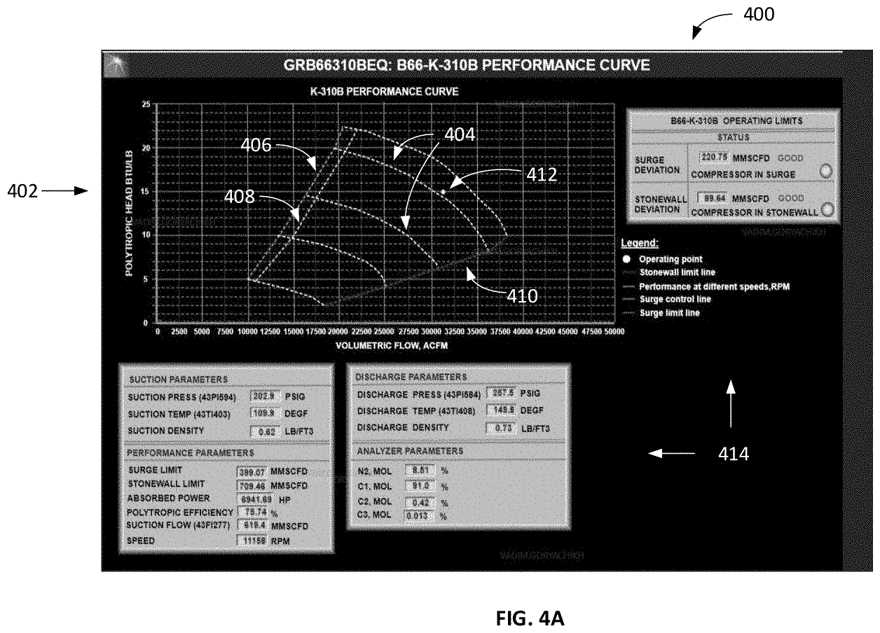

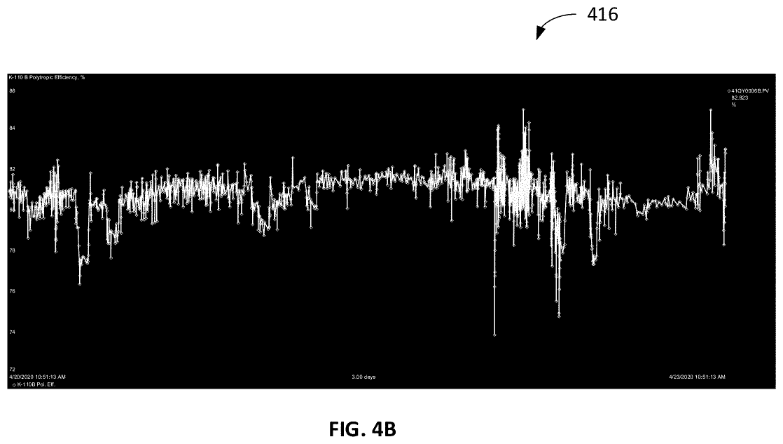

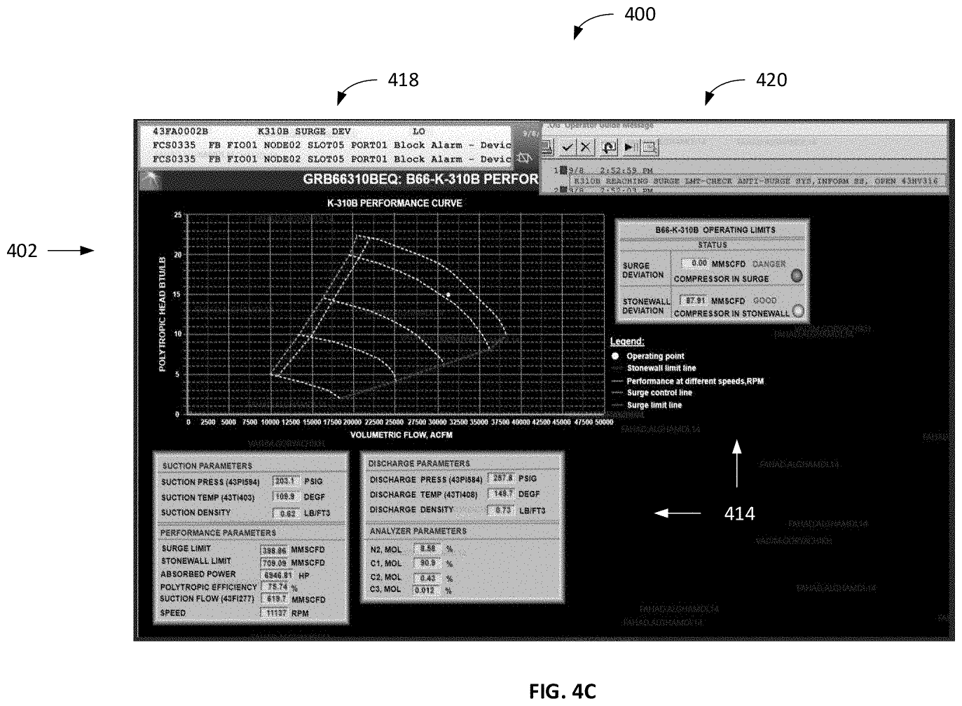

As an example, FIG. 4A shows a graphical dashboard 400 for presenting information to a user during the operation of the system 100. The graphical dashboard 400 can be presented, for example, by the DCS 108 using the display device 110.

In this example, the graphical dashboard 400 includes a portion 402 that displays a graphical representation of one or more performance curves of the system 100. The portion 402 shows a range of possible characteristics of the system 100 during operation with respect multiple different metrics. For instance, in this example, the portion 402 includes a two-dimensional plot having the volumetric flow of gas into the brake compressor 104 (for example, via the inlet 116) as the horizontal dimension and the polytrophic head of the brake compressor 104 as the vertical dimension. Further, the portion 402 includes a sequence of performance curves 404 that graphically represent different ranges of characteristics with respect to different respective rotational speeds of a compression rotor of the brake compressor 104.

Further, the portion 402 can graphically represent a surge limit 406 of the brake compressor 104. The surge limit refers to the minimum flow rate of gas in the brake compressor 104, below which a momentary reversal of gas flow and a reversal of the compression rotor will occur. This condition may be referred to as “surging.” Further, the portion 402 can graphically represent a safety limit 408 relative to the surge limit. The safety limit 408 can be, for example, an offset from the surge limit 406 (for example, representing a minimum flow rate of gas, with a safety margin, to avoid surging in the brake compressor 104).

Further, the portion 402 can graphically represent the stonewall limit 410 of the brake compressor 104. The stonewall limit 410 refers to a condition in which the brake compressor 104 operates at a very high mass flow rate and the flow of gas through the brake compressor cannot be further increased. In some cases, the stonewall limit may be referred to as the “choke line.”

Further, the portion 402 can graphically represent the current operating point 412 of the brake compressor 104. For example, the operating point 412 can indicate the current the volumetric flow of gas through the brake compressor 104 (for example, in the horizontal dimension) and the polytrophic head of the brake compressor 104 (for example, in the vertical dimension). This enables a user to visually ascertain the current operating conditions of the brake compressor 104 and, if needed, modify the operation of the brake compressor 104 to improve its performance. As an example, based on the operating point 412, the user can modify the operation of the brake compressor 104 to stay within a safety envelope (for example, an envelope between the safety limit 408 and the stonewall limit 410).

As shown in FIG. 4A, the graphical dashboard 400 can also a portion 414 that displays additional information regarding the operation of the system 100. For example, the portion 414 can display information regarding the gas that is input into the brake compressor 104 (for example, the “suction” portion of the gas stream). This can include, for instance, the temperature the gas, the pressure of the gas, and the flow rate of the gas.

As another example, the portion 414 can display information regarding the gas that is expelled into the brake compressor 104 (for example, the “discharge” portion of the gas stream). This can include, for example, the temperature the gas, the pressure of the gas, and the flow rate of the gas.

As another example, the portion 414 can display the composition of the gas that is input into or expelled from the brake compressor 104 (for example, the molar proportion or percentage of one or more constituent gasses). In some implementations, this can include an indication of constituent gasses can such as nitrogen gas (abbreviated as “N2”), methane (abbreviated as “C1”), ethane (abbreviated as “C2”), and propane (abbreviated as “C3”), among others.

As another example, the portion 414 can display various performance indicators regarding the brake compressor 104 in text or numerical form. For instance, the portion 414 can display the surge limit, the deviation between the current operating point and the surge limit, the stonewall limit, the deviation between the current operating point and the stonewall limit, the absorbed power, and the polytrophic efficiency. Further, the user can select one or more of the displayed parameters to obtain historical information regarding that the selected parameters. As an example, the user can select the “polytrophic efficiency” parameter. In response, the graphical dashboard 400 can display a plot 416 showing the polytrophic efficiency of the brake compressor over time (for example, as shown in FIG. 4B).

This information can be used, for example, to identify long-term trends, such as performance deterioration of the brake compressor over time. As an example, a decreasing trend in the polytrophic efficiency of the brake compressor 104 can indicate performance deterioration of the internal components of brake compressor 104. Based on this information, the user can take proactive steps to repair, minimize, or otherwise account for the deterioration.

Further, the portion 414 can indicate the status of the brake compressor 104 with respect to the surge limit and the stonewall limit. For example, if the deviation between the current operating point of the brake compressor 104 and the surge limit is within an acceptable range, the portion 414 can provide a “GOOD” indication. However, if the deviation between the current operating point of the brake compressor 104 and the surge limit is exceeds an acceptable range, the portion 414 can provide a “DANGER” indication (for example, as shown in FIG. 4C). The portion 414 can display similar status information with respect to the current operating point and the stonewall limit of the brake compressor 104.

In some implementations, the graphical dashboard 400 can display notifications or alerts to the user, such as notifications regarding danger conditions and guide messages instructing the user to perform certain actions to address the danger conditions. In some implementations, the graphical dashboard 400 can display notification or alerts in the form of pop-up messages (for example, messages overlaid onto the graphical dashboard 400). For example, as shown in FIG. 4C, the graphical dashboard 400 can display a notification 418 that informs the user regarding danger conditions and a guide message 420 instructing the user to perform certain actions to address the danger conditions.

In some implementations, the DCS 108 can obtain sensor data continuously and update the graphical dashboard 400 continuously, such that the user can view information regarding the operation of the system 100 in real-time or substantially real-time. For example, the DCS 108 can continuously update the graphical dashboard 400 with the current operating point of the brake compressor relative to the surge and stonewall limits, the current properties of the input gas, the current properties of the output gas, and the performance indicators for the brake compressor.

### Example Analysis Techniques

Example techniques for analyzing the performance of a turbo-expander brake compressor are described below. In some implementations, these techniques can be performed at least in part by a DCS (for example, the DCS 108), such as a monitoring module of a DCS (for example, the monitoring module 202). Further, as described in further detail below, the DCS can calculate one or more performance characteristics algorithmically based on various inputs.

### Example Input Parameters:

The analysis technique can be performed based on various inputs. Example inputs include the composition of the gas, the properties of the gas that is input into the brake compressor (for example, the “suction” portion of the gas stream), the properties of the gas that is expelled from the brake compressor (for example, the “discharge” portion of the gas stream), and one or more constants.

A. Gas Composition

As an example, the inputs can include the compassion of the gas that is introduced into the brake compressor, such as the molar proportion or percentage of one or more constituent gasses. The constituent gasses can include nitrogen gas (abbreviated as “N2”), methane (abbreviated as “C1”), ethane (abbreviated as “C2”), and propane (abbreviated as “C3”), among others.

B. Suction Parameters;

As another example, the inputs can include the properties of the “suction” portion of the gas stream. This can include the pressure P1, the temperature T1, and the flow rate F of the gas that is input into the brake compressor. Further, the inputs can include the rotational speed S of a compressor rotor of the brake compressor.

In some implementations, the pressure P1 can be expressed in units of pounds per square in gauge (psig). In some implementations, the temperature T1 can be expressed in units Fahrenheit (F). In some implementations, the flow rate F can be expressed in units of million standard cubic feet per day (MMSCFD). In some implementations, the rotational speed S can be expressed in units of rotation per minute (RPM).

In some implementations, the pressure of the gas that is input into the brake compressor can be expressed as an absolute pressure P1_{ABSPA}=(P1+14.7)*6894.75 Pa.

In some implementations, the temperature of the gas that is input into the brake compressor can be expressed in units Kelvin T1_{KELVIN}=(T1−32)*5/9+273.15 K.

C. Discharge Parameters:

As another example, the inputs can include the properties of the “discharge” portion of the gas stream. This can include the pressure P2, the temperature T2 of the gas that is expelled from the brake compressor.

In some implementations, the pressure P2 can be expressed in units of pounds per square in gauge (psig). In some implementations, the temperature T2 can be expressed in units Fahrenheit (F).

In some implementations, the pressure of the gas that is expelled from the brake compressor can be expressed as an absolute pressure P2_{ABSPA}=(P2+14.7)*6894.75 Pa.

In some implementations, the temperature of the gas that is expelled from the brake compressor can be expressed in units Kelvin T2_{KELVIN}=(T2−32)*5/9+273.15 K.

D. Constants

As another example, the inputs can include one or more constants regarding a “standard” condition and a “reference” condition. Example constants include:

Standard pressure P_{std}=101325 Pa (absolute pressure)

Standard temperature T_{std}=288.15 K

Reference pressure P_{ref}=101325 Pa (absolute pressure)

Reference temperature T_{std}=298.15 K

Gas constant R=8.31451 J/K·mol

### Example Calculations:

Various calculations can be performed based on the input parameters. For example, component-derived properties, the compressibility factor, enthalpy, and entropy can be calculated based on the input parameters. Using this calculous, one or more performance characteristics of the turbo-expanded brake compressor can be calculated.

A. Component-Derived Properties a, b, α, K:

Properties a, b, α, K can be calculated for each of the constituent components of the gas that is input into the brake compressor using the following relationships:

$$a = 0.45724 \cdot \frac{{R}^{2} \cdot {T}_{c}^{2}}{{P}_{c}}$$

$$b = 0.0778 \cdot R \cdot \frac{{T}_{c}}{{P}_{c}}$$

$$K = 0.37464 + 1.54226 \cdot ω - 0.26992 \cdot {ω}^{2}$$

$$α = {( 1 + K \cdot ( 1 - \sqrt{\frac{T}{{T}_{c}}} ) )}^{2} ,$$

where ω is the Pitzer's acentric factor of the given component, T_{c} is the critical temperature of the given component, and P_{c} is the critical pressure of the given component.

For example, for components nitrogen gas, methane, ethane, and propane:

| Component | Mol Weight (kg/kmol) | T_{c} (K) | P_{c} (kPa) | ω |
|---|---|---|---|---|
| Nitrogen (N2) | 28.013 | 126.194 | 3394.37 | 0.040000 |
| Methane (C1) | 16.043 | 190.699 | 4640.68 | 0.011498 |
| Ethane (C2) | 30.070 | 305.428 | 4883.85 | 0.098600 |
| Propane (C3) | 44.097 | 369.898 | 4256.66 | 0.152400 |

| Component | Mol Weight (kg/kmol) | T_{c} (K) | P_{c} (kPa) | ω |
|---|---|---|---|---|
| Nitrogen (N2) | 28.013 | 126.194 | 3394.37 | 0.040000 |
| Methane (C1) | 16.043 | 190.699 | 4640.68 | 0.011498 |
| Ethane (C2) | 30.070 | 305.428 | 4883.85 | 0.098600 |
| Propane (C3) | 44.097 | 369.898 | 4256.66 | 0.152400 |

The resulting values for a, b, α, K are:

| Component | a | b | K | α |
|---|---|---|---|---|
| Nitrogen (N2) | 0.148 | 2.41*10⁻⁵ | 0.436 | 0.148* α_{N2} |
| Methane (C1) | 0.248 | 2.66*10⁻⁵ | 0.392 | 0.248* α_{C1} |
| Ethane (C2) | 0.604 | 4.05*10⁻⁵ | 0.524 | 0.604* α_{C2} |
| Propane (C3) | 1.016 | 5.62*10⁻⁵ | 0.603 | 1.016* α_{C3} |

B. Compressibility Factor (Z):

The compressibility factor Z can be calculated by solving Peng-Robinson equation of state (EOS) for a gas mixture. Peng-Robinson EOS is a cubic equation:

Z³−(1−B)·Z²+(A−2B−3B²)·Z−(AB−B²−B³)=0

Coefficients A and B are defined as:

$$A = \frac{{( a \cdot α )}^{mix} \cdot P}{{R}^{2} \cdot {T}^{2}}$$

$$B = \frac{{b}^{mix} \cdot P}{R \cdot T} .$$

For gas mixtures, mixing rules can be applied to obtain (a·α)^{mix} and b^{mix}. For example:

| Mixture | Kij | 1 − kij |
|---|---|---|
| N2C1 | 0.036 | 0.964 |
| N2C2 | 0.05 | 0.95 |
| N2C3 | 0.08 | 0.92 |
| C1C2 | 0.002 | 0.998 |
| C1C3 | 0.007 | 0.993 |
| C2C3 | 0.0013 | 0.9987 |

M_{N2N2}=y_{N2}*y_{N2}*AA_{N2}

M_{C1C1}=y_{C1}*y_{C1}*AA_{C1}

M_{C2C2}=y_{C2}*y_{C2}*AA_{C2}

M_{C3C3}=y_{C3}*y_{C3}*AA_{C3}

M_{N2C1}=0.964*y_{N2}*y_{C1}*(AA_{N2}*AA_{C1})^{0.5}

M_{N2C2}=0.95*y_{N2}*y_{C2}*(AA_{N2}*AA_{C2})^{0.5}

M_{N2C3}=0.92*y_{N2}*y_{C3}*(AA_{N2}*AA_{C3})^{0.5}

M_{C1C2}=0.998*y_{C1}*y_{C2}*(AA_{C1}*AA_{C2})^{0.5}

M_{C1C3}=0.993*y_{C1}*y_{C3}*(AA_{C1}*AA_{C3})^{0.5}

M_{C2C3}=0.9987*y_{C2}*y_{C3}*(AA_{C2}*AA_{C3})^{0.5}

MIX_{N2}=M_{N2N2}+M_{N2C1}+M_{N2C2}+M_{N2C3}

MIX_{C1}=M_{C1C1}+M_{N2C1}+M_{C1C2}+M_{C1C3}

MIX_{C2}=M_{C2C2}+M_{N2C2}+M_{C1C2}+M_{C2C3}

MIX_{C3}=M_{C3C3}+M_{N2C3}+M_{C1C3}+M_{C2C3}

(a·α)^{mix}=MIX_{N2}+MIX_{C1}+MIX_{C2}+MIX_{C3}

b^{mix}=Σyᵢ·bᵢ,

where kᵢⱼ are binary interaction parameters for the pairs of components.

For example, for components nitrogen gas, methane, ethane, and propane:

Binary interaction parameters

| | Nitrogen | Methane | Ethane | Propane |
|---|---|---|---|---|
| | (N2) | (C1) | (C2) | (C3) |
| Nitrogen | 0 | 0.035999 | 0.050000 | 0.079998 |
| (N2) | | | | |
| Methane | 0.035999 | 0 | 0.002241 | 0.006829 |
| (C1) | | | | |
| Ethane | 0.050000 | 0.002241 | 0 | 0.001258 |
| (C2) | | | | |
| Propane | 0.079998 | 0.006829 | 0.001258 | 0 |
| (C3) | | | | |

Solution of the cubic EOS includes several steps. Given the cubic equation with real coefficients

Z³+a·Z²+b·Z+c=0,

the first step is to calculate the parameters:

$$p = b - \frac{{a}^{2}}{3}$$

$$q = 2 \cdot \frac{{a}^{3}}{27} - a \cdot \frac{b}{3} + c$$

Note that the coefficients a and b here are not the same as those used in the component-derived properties in EOS. Here, they are auxiliary variables used to solve the cubic equation.

For Peng-Robinson equation these coefficients will be:

a=B−1

b=A−2B−3·B²

c=B³+B²−A·B.

The second step is to define discriminant:

$$r = {( \frac{p}{3} )}^{3} + {( \frac{q}{2} )}^{2} .$$

Third step is to calculate compressibility factor Z:

1) If r>0, then

$$Z 1 = {( - \frac{q}{2} + \sqrt{r} )}^{1 \text{/} 3} + {( - \frac{q}{2} - \sqrt{r} )}^{1 \text{/} 3} - \frac{a}{3} .$$

2) If r=0, then two roots available and highest value selected:

$$Z 1 = - 2 \cdot {( \frac{q}{2} )}^{1 \text{/} 3} - \frac{a}{3}$$

$$Z 2 = - {( \frac{q}{2} )}^{\frac{1}{3}} - \frac{a}{3} .$$

3) If r<0, then three roots available and highest selected:

$$Z 1 = 2 \cdot ( \sqrt{( - \frac{p}{3} )} \cdot cos ( \frac{acos ( \sqrt{\frac{\frac{{q}^{2}}{4}}{- \frac{{p}^{3}}{27}}} )}{3} ) - \frac{a}{3} \\ Z 2 = 2 \cdot ( \sqrt{( - \frac{p}{3} )} \cdot cos ( ( \frac{acos ( \sqrt{\frac{\frac{{q}^{2}}{4}}{- \frac{{p}^{3}}{27}}} )}{3} ) + 2.09 ) - \frac{a}{3} \\ Z 3 = 2 \cdot ( \sqrt{( - \frac{p}{3} )} \cdot cos ( ( \frac{acos ( \sqrt{\frac{\frac{{q}^{2}}{4}}{- \frac{{p}^{3}}{27}}} )}{3} ) + 1.05 ) ) - \frac{a}{3} .$$

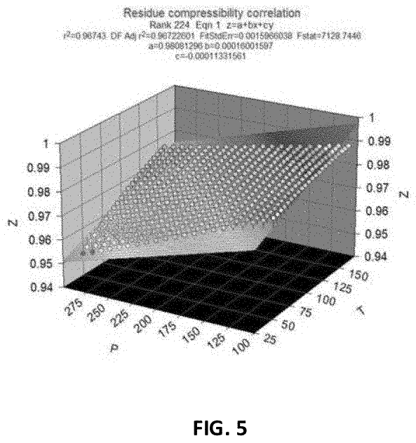

Alternatively, gas compressibility Z can be obtained by building correlations. FIG. 5 shows an example Z-correlation for residue gas in an example natural gas recovery plant. In this example, a correlation (represented by a multi-dimensional surface) is determined based on parameters Z, pressure P, and temperature T.

Correlations allow for the calculation of gas mixture compressibility factor using only one formula obtained from the correlations. For instance, based on graph shown in FIG. 4, the compressibility equation will be:

$$Z = \frac{( a + b * T - c * {T}^{2} + d * P )}{( 1 + e * T + f * {T}^{2} + g * P )} ,$$

where:
T is the stream temperature in Fahrenheit,
P is the stream pressure in pounds per square inch (psi), and
a, b, c, d, e, f, g are equation coefficients, where:
a=0.99996428,
b=0.0062149212,
c=4.1551099×10⁻⁵,
d=7.7558113×10⁻⁵,
e=0.0062677135,
f=4.1390104×10⁻⁵, and
g=0.00032572002.

Compressibility factor Z can be calculated for inlet and outlet conditions Z1 and Z2.

C. Enthalpy

To calculate enthalpy, a reference enthalpy can be defined at a given temperature and pressure, and the change in enthalpy to the actual pressure and temperature can be calculated in two steps. First an ideal step (no change in pressure) is calculated, then a departure function is used to account for non-ideality at high pressure:

H=H_{ref}+dH^{ideal}+H^{departure}

a. Calculate Reference Enthalpy

Reference enthalpy is sum of components mole fractions multiplied by enthalpy of formation at reference conditions

H_{ref}=Σyᵢ·dHᵢ⁰,

where:
yᵢ is the mole fraction of component i,
dHᵢ⁰ is the enthalpy of formation of component i at reference conditions, kJ/kmol.

| | dHᵢ⁰ | dSᵢ⁰ |
|---|---|---|
| Component | (kJ/kmol) | (kJ/(kmol · K)) |
| Nitrogen (N2) | 0 | 148.063 |
| Methane (C1) | −74900 | 183.476 |
| Ethane (C2) | −84738 | 195.219 |
| Propane (C3) | −103890 | 161.655 |

b. Calculate Ideal Enthalpy for Each Component:

The ideal enthalpy for each component can be calculated using the relationship:

$${dH}_{i}^{ideal} = A \cdot ( T - {T}_{ref} ) + \frac{B}{2} \cdot ( {T}^{2} - {T}_{ref}^{2} ) + \frac{C}{3} \cdot ( {T}^{3} - {T}_{ref}^{3} ) + \frac{D}{4} \cdot ( {T}^{4} - {T}_{ref}^{4} ) + \frac{E}{5} \cdot ( {T}^{5} - {T}_{ref}^{5} ) ,$$

where:
T_{ref} is a reference temperature (298.15 K),
T is an actual temperature, K, and
A, B, C, D, E are coefficients:

| Component | A | B | C | D | E |
|---|---|---|---|---|---|
| Nitrogen | 2.753E+01 | 5.443E−03 | −3.494E−08 | −4.096E−10 | 5.673E−14 |
| Methane | 3.793E+01 | −6.842E−02 | 2.725E−04 | −2.390E−07 | 6.906E−11 |
| Ethane | 3.437E+01 | −1.946E−02 | 3.828E−04 | −4.081E−07 | 1.326E−10 |
| Propane | 1.742E+01 | 1.865E−01 | 5.245E−05 | −1.177E−07 | 3.703E−11 |

Ideal enthalpy for mixture can be calculated as:

dH_{ideal}=ΣyᵢdHᵢ^{ideal}.

Departure enthalpy can be calculated using the relationship:

$${H}^{departure} = ( 1 - Z - ln \frac{Z + ( 1 + \sqrt{2} ) \cdot B}{Z + ( 1 - \sqrt{2} ) \cdot B} \cdot \frac{A}{B \cdot \sqrt{8}} \cdot ( 1 + {K}^{mix} \cdot \frac{\sqrt{\frac{T}{{T}_{c}^{mix}}}}{\sqrt{{α}^{mix}}} ) ) \cdot R \cdot T ,$$

where:
Z is a compressibility of the gas.
T_{c}^{mix} is critical temperature of the gas mixture, K,
A, B are coefficients from Peng-Robinson EOS,
α^{mix}, K^{mix} are component-derived properties for the gas mixture, and
R is the gas constant, 8.3144 J/(mol·K).

Critical temperature for the gas mixture is calculated as:

T_{c}^{mix}=ΣTᵢ^{c}·yᵢ,

where Tᵢ^{c} is a critical temperature of the component i, and

| Component | Mol Weight (kg/kmol) | T_{c} (K) | P_{c} (kPa) |
|---|---|---|---|
| Nitrogen (N2) | 28.013 | 126.194 | 3394.37 |
| Methane (C1) | 16.043 | 190.699 | 4640.68 |
| Ethane (C2) | 30.070 | 305.428 | 4883.85 |
| Propane (C3) | 44.097 | 369.898 | 4256.66 |

Similar to critical temperature parameters K and α for the gas mixture are calculated as:

K^{mix}=ΣKᵢ·yᵢ

α^{mix}=Σαᵢ·yᵢ.

c. Calculate Stream Enthalpy:

Stream enthalpy can be calculated using the following relationship:

H=H_{ref}dH^{ideal}+H^{departure}

Calculated enthalpy will be in kJ/kmol units. To convert it to BTU/lb, first calculate molecular weight of gas mixture:

MW=N2_{MOL}*28+C1_{MOL}*16+C2_{MOL}*30+C3_{MOL}*44.

Second, convert enthalpy from kJ/kmol to BTU/lb

$${H}_{BTU} = \frac{{H}_{kJ}}{MW} * 0.429923 .$$

D. Entropy

Entropy can calculated in a similar manner as with enthalpy. For example, initially reference entropy at a given temperature and pressure can calculated. Then a change in entropy to the actual pressure and temperature can be cleated in two steps. First, an ideal step (no change in pressure) can be calculated. Second, a departure function can be used to account for non-ideality at high pressure. Additionally, entropy of mixing is calculated.

$$S = {S}_{ref} + {dS}^{ideal} + {S}^{departure} + {dS}^{mixing} - R \cdot ln \frac{P}{{P}_{ref}} .$$

a. Calculate Reference Entropy

Reference entropy is sum of components mole fractions multiplied by entropy of formation at reference conditions:

S_{ref}=Σyᵢ·dSᵢ⁰,

where dSᵢ⁰ is the enthalpy of formation of component i at reference conditions, kJ/(kmol·K).

b. Calculate Ideal Entropy for Each Component:

Ideal entropy for each component can be calculated using the following relationship:

$${dS}_{i}^{ideal} = A \cdot ln \frac{T}{{T}_{ref}} + B \cdot ( T - {T}_{ref} ) + \frac{C}{2} \cdot ( {T}^{2} - {T}_{ref}^{2} ) + \frac{D}{3} \cdot ( {T}^{3} - {T}_{ref}^{3} ) + \frac{E}{4} \cdot ( {T}^{4} - {T}_{ref}^{4} ) .$$

Ideal entropy for mixture can be calculated using the relationship:

dS_{ideal}=Σyᵢ·dSᵢ^{ideal}.

c. Calculate Departure Entropy:

Departure entropy can be calculated using the relationship:

$${S}^{departure} = R \cdot ln ( Z - B ) - ln \frac{Z + ( 1 + \sqrt{2} ) \cdot B}{Z + ( 1 - \sqrt{2} ) \cdot B} \cdot \frac{A \cdot R}{B \cdot \sqrt{8}} \cdot {K}^{mix} \cdot \frac{\sqrt{\frac{T}{{T}_{c}^{mix}}}}{\sqrt{{α}^{mix}}} .$$

d. Calculate Mixing Entropy for Key Components:

Mixing entropy for key components (such as nitrogen and methane) can be calculated using the relationship:

dS^{mixing}=−R·(N₂_{_{MOL}}·ln(N₂_{_{MOL}})+C₁_{_{MOL}}·ln(C₁_{_{MOL}})).

e. Calculate steam entropy:

Stream entropy can calculated using the relationship:

$$S = {S}_{ref} + {dS}^{ideal} + {S}^{departure} + {dS}^{mixing} - R \cdot ln \frac{P}{{P}_{ref}} .$$

E. Performance characteristics regarding the operation of the system

Several performance characters regarding the operation of the system can be determined based on the calculations above.

As an example, polytrophic head can be calculated using the relationship:

$${H}_{P} = ( {H}_{2} - {H}_{1} ) - \frac{( {S}_{2} - {S}_{1} ) \cdot ( {T}_{2} - {T}_{1} )}{ln \frac{{T}_{2}}{{T}_{1}}} .$$

As another example, polytrophic efficiency can be calculated using the relationship:

$$η = \frac{{H}_{P}}{{H}_{2} - {H}_{1}} .$$

As another example, the actual suction flow of the brake compressor can be calculated using the relationship:

$${F}_{act} , ACFM = {F}_{std} , MMSCFD * ( \frac{{P}_{std}}{{P}_{act}} ) * ( \frac{{T}_{act}}{{T}_{std}} ) * ( \frac{z}{1} ) * {10}^{6} * ( \frac{1}{24} ) * ( \frac{1}{60} ) .$$

As another example, the stonewall limit of the brake compressor can be calculated using the relationship:

$${F}_{stonewall} , ACFM = Speed , rpm * 3.2$$

$${F}_{stonewall} , MMSCFD = {F}_{stonewall} , ACFM * ( \frac{{P}_{act}}{{P}_{std}} ) * ( \frac{{T}_{std}}{{T}_{act}} ) * ( \frac{1}{z} ) * ( \frac{1}{{10}^{6}} ) * 24 * 60.$$

As another example, the deviation from stonewall limit can be calculated using the relationship:

Dev_{stonewall}=Fₛₜₒₙₑₐₗₗ,MMSCFD−F_{std},MMSCFD

In some implementations, the deviation reaches critical set point (such as +10 MMSCFD), the dashboard status can change from “GOOD” to “DANGER.” Further, the dashboard can present a notification to assist the operator in remedying the issue (for example, a message instructing the operator to reduce flow through the machine). In practice, other set points values are also possible.

As another example, the surge limit of the brake compressor can be calculated using the relationship:

$${F}_{surge} , ACFM = Speed , rpm * 1.8$$

$${F}_{surge} , MMSCFD = {F}_{surge} , ACFM * ( \frac{{P}_{act}}{{P}_{std}} ) * ( \frac{{T}_{std}}{{T}_{act}} ) * ( \frac{1}{z} ) * ( \frac{1}{{10}^{6}} ) * 24 * 60.$$

As another example, the deviation from stonewall limit can be calculated using the relationship:

Dev_{stonewall}=F_{std},MMSCFD−F_{surge},MMSCFD.

In some implementations, if the deviation reaches critical set point (such as +10 MMSCFD), dashboard status can change from “GOOD” to “DANGER.” Further, the dashboard can present a notification to assist the operator in remedying the issue (for example, a message instructing the operator to check the functionality of the brake compressor's anti-surge system).

As another example, inlet/outlet stream densities can be calculated using the relationship:

$${Density}_{IN} , \frac{lb}{{ft}^{3}} = \frac{{P}_{in} * MW}{{Z}_{in} * R * {T}_{in}} * 0.0624$$

$${Density}_{OUT} , \frac{lb}{{ft}^{3}} = \frac{{P}_{out} * MW}{{Z}_{out} * R * {T}_{out}} * 0.0624 .$$

As another example, the mass flow of the brake compressor can be calculated using the relationship:

$${F}_{mass} , \frac{lb}{h} = {F}_{act} , ACFM * {Density}_{IN} , \frac{lb}{{ft}^{3}} * 60.$$

As another example, compressor power can be calculated using the relationship:

$$POWER , HP = \frac{( {H}_{p} , \frac{BTU}{lb} * {F}_{mass} , \frac{lb}{h} )}{41.83}$$

One or more of the performance characteristics above can be presented on a graphical dashboard (for example, the graphical dashboard 400) continuously and in real-time or substantially real-time. Further, the graphical dashboard can present additional information, such as the actual operating point of the brake compressor overlaid on a graphical presentation of a performance curve (for example, as described with respect to FIG. 4).

### Example Processes

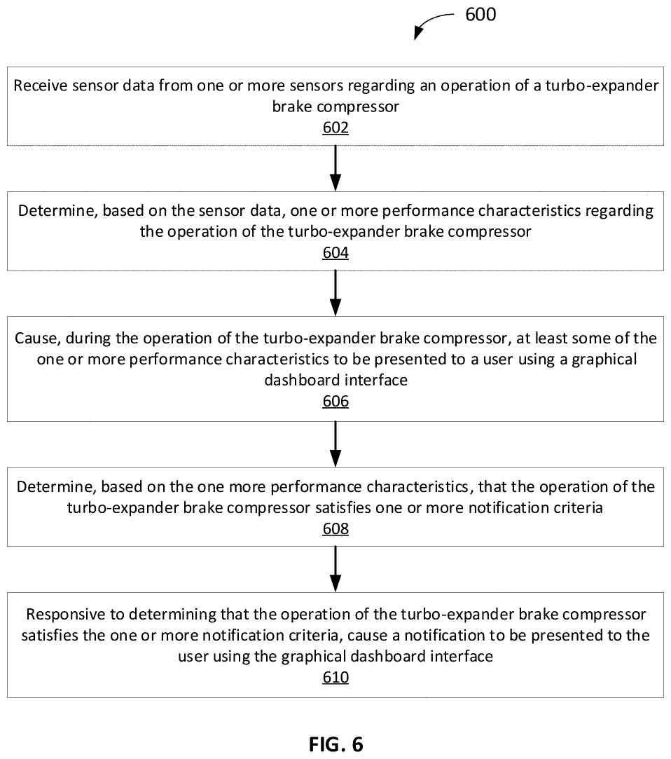

An example process 600 for monitoring the operation of a turbo-expander brake compressor is shown in FIG. 6. In some implementations, the process 600 can be performed by the distributed control systems or monitoring modules described in this disclosure (for example, the DCS 108 and the monitoring module 202 shown and described with respect to FIGS. 1-5).

In the process 600, a distributed control system (DCS) receives sensor data from one or more sensors regarding an operation of a turbo-expander brake compressor (step 602). As an example, referring to FIG. 1, a DCS 108 can receive sensor data from the sensors 106. In some implementations, the DCS can receive the sensor data continuously during the operation of the turbo-expander brake compressor.

The DCS can receive various types of sensor data. As an example, the DCS can receive sensor data such as an indication of a composition of input gas directed into the turbo-expander brake compressor during the operation of the turbo-expander brake compressor, an indication of a pressure of the input gas, an indication of a temperature of the input gas, or an indication of a flow rate of the input gas. As another example, the DCS can receive sensor data such as an indication of a rotational speed of a component of the turbo-expander brake compressor during the operation of the turbo-expander brake compressor (for example, a compression rotor). As another example, the DCS can receive sensor data such as an indication of a pressure of output gas discharged from the turbo-expander brake compressor during the operation of the turbo-expander brake compressor, or an indication of a temperature of the output gas.

The DCS determines, based on the sensor data, one or more performance characteristics regarding the operation of the turbo-expander brake compressor (step 604). In some implementations, the DCS can determine the one or more performance characteristics continuously during the operation of the turbo-expander brake compressor. In some implementations, at least some of the one or more performance characteristics can be determined algorithmically.

The DCS can determine various types of performance characteristics based on the sensor data. As an example, the DCS can determine a surge limit of the turbo-expander brake compressor, and a deviation of the turbo-expander brake compressor from the surge limit during the operation of the turbo-expander brake compressor. As another example, the DCS can determine a stonewall limit of the turbo-expander brake compressor, and a deviation of the turbo-expander brake compressor from the stonewall limit during the operation of the turbo-expander brake compressor. As another example, the DCS can determine a polytrophic efficiency of the turbo-expander brake compressor during the operation of the turbo-expander brake compressor. As another example, the DCS can determine an absorbed power of the turbo-expander brake compressor during the operation of the turbo-expander brake compressor. As another example, the DCS can determine an operating point of the turbo-expander brake compressor relative to a performance curve of the turbo-expander brake compressor. Example techniques for determining performance characteristics in the “Example Analysis Techniques” section above.

The DCS causes, during the operation of the turbo-expander brake compressor, at least some of the one or more performance characteristics to be presented to a user using a graphical dashboard interface (step 606).

The DCS determines, based on the one more performance characteristics, that the operation of the turbo-expander brake compressor satisfies one or more notification criteria (step 608).

Response to determining that the operation of the turbo-expander brake compressor satisfies the one or more notification criteria, the DCS causes a notification to be presented to the user using the graphical dashboard interface (step 610).

In some implementations, determining that the operation of the turbo-expander brake compressor satisfies the one or more notification criteria can include determining that the operation of the turbo-expander brake has exceeded a safety limit associated with the turbo-expander brake compressor (for example, a surge limit or a stonewall limit). The notification can include an indication that the operation of the turbo-expander brake has exceeded the safety limit.

In some implementations, determining that the operation of the turbo-expander brake compressor satisfies the one or more notification criteria can include determining that the operation of the turbo-expander brake is approaching a safety limit associated with the turbo-expander brake compressor (for example, a surge limit or a stonewall limit). The notification can include an indication that the operation of the turbo-expander brake is approaching the safety limit.

In some implementations, the DCS can cause at least some of the one or more performance characteristics to be presented to the user continuously during the operation of the turbo-expander brake compressor. As an example, referring to FIGS. 4A and 4B, the DCS can cause at least some of the one or more performance characteristics to be displayed using a graphical dashboard 400. In some implementations, the graphical dashboard interface can include a graphical representation of the operating point overlaid on a graphical representation of the performance curve (for example, as shown in FIG. 4A).

In some implementations, the DCS can determine, based on the one more performance characteristics, an estimated future deterioration of the turbo-expander brake compressor. Further, the DCS can cause an indication of the estimated future deterioration to be presented to the user using the graphical dashboard interface.

### Example Systems

Some implementations of the subject matter and operations described in this specification can be implemented in digital electronic circuitry, or in computer software, firmware, or hardware, including the structures disclosed in this specification and their structural equivalents, or in combinations of one or more of them. For example, in some implementations, one or more components of the DCS 108 or the monitoring module 202 can be implemented using digital electronic circuitry, or in computer software, firmware, or hardware, or in combinations of one or more of them. In another example, the process shown in FIG. 6 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, that is, one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (for example, multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, for example, magnetic, magneto optical disks, or optical disks. However, a computer need not have such devices. Devices suitable for storing computer program instructions and data include all forms of non-volatile memory, media and memory devices, including by way of example semiconductor memory devices (for example, EPROM, EEPROM, AND flash memory devices), magnetic disks (for example, internal hard disks, and removable disks), magneto optical disks, and CD-ROM and DVD-ROM disks. The processor and the memory can be supplemented by, or incorporated in, special purpose logic circuitry.

To provide for interaction with a user, operations can be implemented on a computer having a display device (for example, a monitor, or another type of display device) for displaying information to the user. The computer can also include a keyboard and a pointing device (for example, a mouse, a trackball, a tablet, a touch sensitive screen, or another type of pointing device) by which the user can provide input to the computer. Other kinds of devices can be used to provide for interaction with a user as well. For example, feedback provided to the user can be any form of sensory feedback, such as visual feedback, auditory feedback, or tactile feedback. Input from the user can be received in any form, including acoustic, speech, or tactile input. In addition, a computer can interact with a user by sending documents to and receiving documents from a device that is used by the user. For example, a computer can send webpages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (for example, the Internet), a network comprising a satellite link, and peer-to-peer networks (for example, ad hoc peer-to-peer networks). A relationship of client and server may arise by virtue of computer programs running on the respective computers and having a client-server relationship to each other.

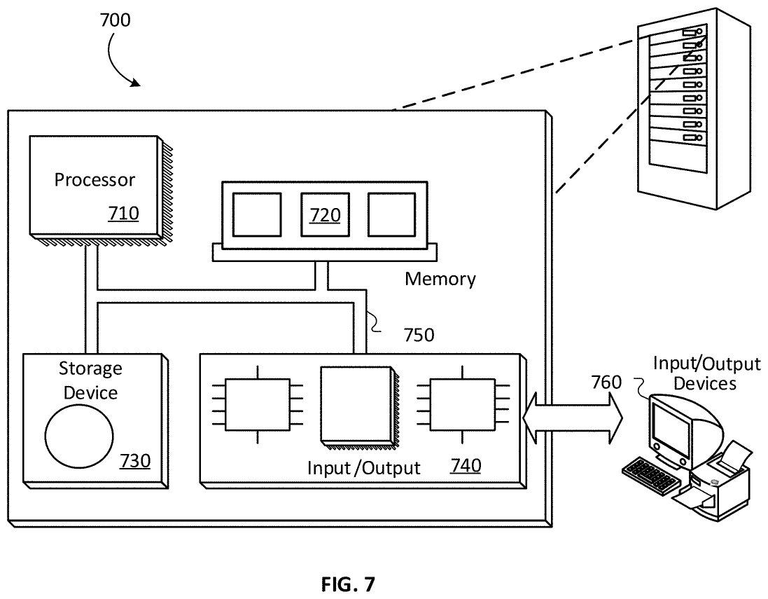

FIG. 7 shows an example computer system 700 that includes a processor 710, a memory 720, a storage device 730 and an input/output device 740. Each of the components 710, 720, 730 and 740 can be interconnected, for example, by a system bus 750. In some implementations, the computer system 700 can be used to control the operation of a spectrometer. For example, the DCS 108 in FIG. 1 can include a computer system 700 to monitor the operation of a turbo-expander brake compressor. The processor 710 is capable of processing instructions for execution within the system 700. In some implementations, the processor 710 is a single-threaded processor, a multi-threaded processor, or another type of processor. The processor 710 is capable of processing instructions stored in the memory 720 or on the storage device 730. The memory 720 and the storage device 730 can store information within the system 700.

The input/output device 740 provides input/output operations for the system 700. In some implementations, the input/output device 740 can include one or more of a network interface device, for example, an Ethernet card, a serial communication device, for example, an RS-232 port, or a wireless interface device, for example, an 802.11 card, a 3G wireless modem, a 4G wireless modem, or a 5G wireless modem, or both. In some implementations, the input/output device can include driver devices configured to receive input data and send output data to other input/output devices, for example, keyboard, printer and display devices 760. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, various modifications may be made without departing from the spirit and scope of the invention. Accordingly, other embodiments are within the scope of the claims.

What is claimed is:

1. A method comprising:
receiving, by a distributed control system, sensor data from one or more sensors regarding an operation of a turbo-expander brake compressor;
determining, by the distributed control system based on the sensor data, one or more performance characteristics regarding the operation of the turbo-expander brake compressor;
causing, by the distributed control system during the operation of the turbo-expander brake compressor, at least some of the one or more performance characteristics to be presented to a user using a graphical dashboard interface;
determining, by the distributed control system based on the one more performance characteristics, that the operation of the turbo-expander brake compressor satisfies one or more notification criteria; and
responsive to determining that the operation of the turbo-expander brake compressor satisfies the one or more notification criteria, causing, by the distributed control system, a notification to be presented to the user using the graphical dashboard interface.

2. The method of claim 1, wherein the sensor data is received continuously during the operation of the turbo-expander brake compressor.

3. The method of claim 1, wherein the one or more performance characteristics are determined continuously during the operation of the turbo-expander brake compressor.

4. The method of claim 1, wherein the distributed control system causes the at least some of the one or more performance characteristics to be presented to the user continuously during the operation of the turbo-expander brake compressor.

5. The method of claim 1, wherein the sensor data comprises at least one of:
an indication of a composition of input gas directed into the turbo-expander brake compressor during the operation of the turbo-expander brake compressor,
an indication of a pressure of the input gas,
an indication of a temperature of the input gas, or
an indication of a flow rate of the input gas.

6. The method of claim 1, wherein the sensor data comprises:
an indication of a rotational speed of a component of the turbo-expander brake compressor during the operation of the turbo-expander brake compressor.

7. The method of claim 1, wherein the sensor data comprises at least one of:
an indication of a pressure of output gas discharged from the turbo-expander brake compressor during the operation of the turbo-expander brake compressor, or
an indication of a temperature of the output gas.

8. The method of claim 1, wherein the one or more performance characteristics comprise:
a surge limit of the turbo-expander brake compressor, and
a deviation of the turbo-expander brake compressor from the surge limit during the operation of the turbo-expander brake compressor.

9. The method of claim 1, wherein the one or more performance characteristics comprise:
a stonewall limit of the turbo-expander brake compressor, and
a deviation of the turbo-expander brake compressor from the stonewall limit during the operation of the turbo-expander brake compressor.

10. The method of claim 1, wherein the one or more performance characteristics comprise:
a polytrophic efficiency of the turbo-expander brake compressor during the operation of the turbo-expander brake compressor.

11. The method of claim 1, wherein the one or more performance characteristics comprise:
an absorbed power of the turbo-expander brake compressor during the operation of the turbo-expander brake compressor.

12. The method of claim 1, wherein the one or more performance characteristics comprise:
an operating point of the turbo-expander brake compressor relative to a performance curve of the turbo-expander brake compressor.

13. The method of claim 12, wherein the graphical dashboard interface comprises:
a graphical representation of the operating point overlaid on a graphical representation of the performance curve.

14. The method of claim 1, wherein determining that the operation of the turbo-expander brake compressor satisfies the one or more notification criteria comprises:
determining that the operation of the turbo-expander brake has exceeded a safety limit associated with the turbo-expander brake compressor.

15. The method of claim 14, wherein the notification comprises an indication that the operation of the turbo-expander brake has exceeded the safety limit.

16. The method of claim 1, wherein determining that the operation of the turbo-expander brake compressor satisfies the one or more notification criteria comprises:
determining that the operation of the turbo-expander brake is approaching a safety limit associated with the turbo-expander brake compressor.

17. The method of claim 16, wherein the notification comprises an indication that the operation of the turbo-expander brake is approaching the safety limit.

18. The method of claim 1, further comprising:
determining, by the distributed control system based on the one more performance characteristics, an estimated future deterioration of the turbo-expander brake compressor, and
causing, by the distributed control system, an indication of the estimated future deterioration to be presented to the user using the graphical dashboard interface.

19. A system comprising:
one or more processors; and
one or more non-transitory computer-readable media including one or more sequences of instructions which, when executed by the one or more processors, causes the one or more processors to perform operations comprising:
receiving sensor data from one or more sensors regarding an operation of a turbo-expander brake compressor;
determining, based on the sensor data, one or more performance characteristics regarding the operation of the turbo-expander brake compressor;
causing, during the operation of the turbo-expander brake compressor, at least some of the one or more performance characteristics to be presented to a user using a graphical dashboard interface;
determining, based on the one more performance characteristics, that the operation of the turbo-expander brake compressor satisfies one or more notification criteria; and
responsive to determining that the operation of the turbo-expander brake compressor satisfies the one or more notification criteria, causing a notification to be presented to the user using the graphical dashboard interface.

20. One or more non-transitory computer-readable media including one or more sequences of instructions which, when executed by the one or more processors, causes the one or more processors to perform operations comprising:
receiving sensor data from one or more sensors regarding an operation of a turbo-expander brake compressor;
determining, based on the sensor data, one or more performance characteristics regarding the operation of the turbo-expander brake compressor;
causing, during the operation of the turbo-expander brake compressor, at least some of the one or more performance characteristics to be presented to a user using a graphical dashboard interface;
determining, based on the one more performance characteristics, that the operation of the turbo-expander brake compressor satisfies one or more notification criteria; and
responsive to determining that the operation of the turbo-expander brake compressor satisfies the one or more notification criteria, causing a notification to be presented to the user using the graphical dashboard interface.
